(19) United States
(12) Patent Application Publication
(10) Pub. No.: US 2026/0179834 A1
(43) Pub. Date: Jun. 25, 2026

(54) MULTILAYER ELECTRONIC COMPONENT

(71) Applicant: SAMSUNG ELECTRO-MECHANICS CO., LTD., Suwon-si (KR)

(72) Inventor: Sung Woo Kang, Suwon-si (KR)

(73) Assignee: SAMSUNG ELECTRO-MECHANICS CO., LTD., Suwon-si (KR)

(21) Appl. No.: 19/365,941

(22) Filed: Oct. 22, 2025

(30) Foreign Application Priority Data
Dec. 24, 2024 (KR) 10-2024-0194889

(51) Int. Cl. H01G 2/08; H01G 4/30

(52) U.S. Cl. CPC H01G 2/08; H01G 4/30

(57) ABSTRACT

A multilayer electronic component includes a body including a dielectric layer and internal electrodes alternately disposed within the dielectric layer in a first direction, the body having first and second surfaces opposing in the first direction, third and fourth surfaces connected to the first and second surfaces and opposing in a second direction, and fifth and sixth surfaces connected to the first to fourth surfaces and opposing in the third direction, and external electrodes disposed on the third and fourth surfaces, respectively. At least one of the internal electrodes is spaced apart from the fifth and sixth surfaces with a margin portion therebetween, and a through-hole may be disposed in the margin portion, and the through-hole may penetrate the first and second surfaces and may have an empty space therein.

### CROSS-REFERENCE TO RELATED APPLICATION(S)

This application claims benefit of priority to Korean Patent Application No. 10-2024-0194889 filed on Dec. 24, 2024 in the Korean Intellectual Property Office, the disclosure of which is incorporated herein by reference in its entirety

### TECHNICAL FIELD

The present disclosure relates to a multilayer electronic component.

### BACKGROUND ART

A multilayer ceramic capacitor (MLCC), a multilayer electronic component, is a chip-type condenser, mounted on the printed circuit boards of various types of electronic product, such as image display devices including a liquid crystal display LCD and a plasma display panel PDP, computers, smartphones and mobile phones, and serves to charge or discharge electricity therein or therefrom. Such multilayer ceramic capacitors may be used as a component in various electronic devices due to having a small size, ensuring high capacitance and being easily mounted.

Recently, as MLCCs have become smaller and have been implemented with higher capacitance, a heat generation problem of MLCCs is becoming more important. When a voltage is applied to the MLCC, heat is generated inside the MLCC, and the heat generated inside the MLCC is a factor that adversely affects electrical characteristics and lifespan characteristics of the MLCC. Accordingly, research into new structures to effectively release the heat generated inside the MLCC is necessary.

### DISCLOSURE OF INVENTION

### Technical Problem

An aspect of the present disclosure is to improve the reliability of a multilayer electronic component by effectively releasing heat generated inside a multilayer electronic component.

However, problems to be solved by the present disclosure are not limited to the above, and will be more easily understood in the process of describing specific embodiments of the present disclosure.

### Solution to Problem

A multilayer electronic component according to an embodiment of the present disclosure may comprise: a body including a dielectric layer and internal electrodes alternately disposed within the dielectric layer in a first direction, the body having first and second surfaces opposing each other in the first direction, third and fourth surfaces connected to the first and second surfaces and opposing each other in a second direction, and fifth and sixth surfaces connected to the first to fourth surfaces and opposing each other in a third direction; and external electrodes disposed on the third and fourth surfaces respectively, wherein at least one of the internal electrodes is spaced apart from the fifth and sixth surfaces with a margin portion therebetween, and a through-hole may be disposed in the margin portion, and the through-hole may penetrate the first and second surfaces and may have an empty space therein.

### Advantageous Effects of Invention

According to an aspect of the present disclosure, the reliability of the multilayer electronic component may be improved by effectively releasing heat generated inside the multilayer electronic component.

### BRIEF DESCRIPTION OF DRAWINGS

FIG. 1 is a perspective view schematically illustrating a multilayer electronic component according to an embodiment of the present disclosure.

FIG. 2 schematically illustrates a cross-sectional view taken along line I-I′ of FIG. 1.

FIG. 3 schematically illustrates a cross-sectional view taken along line II-II′ of FIG. 1.

FIGS. 4A and 4B are enlarged views schematically illustrating Region K1 of FIG. 3.

FIG. 5 schematically illustrates a cross-sectional view taken along line III-III′ of FIG. 1.

FIG. 6 is a cross-sectional view illustrating a state in which the multilayer electronic component according to an embodiment of the present disclosure is mounted on a printed circuit board.

FIG. 7 is a cross-sectional view schematically illustrating a multilayer electronic component according to another embodiment of the present disclosure, and is a drawing corresponding to FIG. 5.

FIG. 8 is a cross-sectional view schematically illustrating a multilayer electronic component according to another embodiment of the present disclosure, and is a drawing corresponding to FIG. 5.

FIG. 9 is a perspective view schematically illustrating a method for manufacturing the multilayer electronic component according to an embodiment of the present disclosure.

### DESCRIPTION OF REFERENCE CHARACTERS

Hereinafter, embodiments of the present disclosure will be described with reference to specific embodiments and the accompanying drawings. However, embodiments of the present disclosure may be modified to have various other forms, and the scope of the present disclosure is not limited to the embodiments described below. Further, embodiments of the present disclosure may be provided for a more complete description of the present disclosure to the ordinary artisan. Therefore, shapes and sizes of the elements in the drawings may be exaggerated for clarity of description, and the elements denoted by the same reference numerals in the drawings may be the same elements.

In the drawings, portions not related to the description will be omitted for clarification of the present disclosure, and a thickness may be enlarged to clearly illustrate layers and regions. The same reference numerals will be used to designate the same components with the same reference numerals. Further, throughout the specification, when an element is referred to as “comprising” or “including” an element, it means that the element may further include other elements as well, without departing from the other elements, unless specifically stated otherwise.

In the drawings, a first direction X may be defined as a thickness T direction, a second direction Y may be defined as a length L direction, and a third direction Z may be defined as a width W direction.

### Multilayer Electronic Component

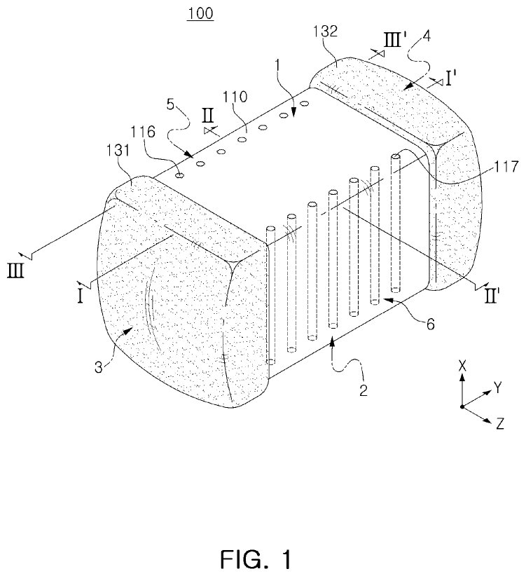

FIG. 1 is a perspective view schematically illustrating a multilayer electronic component according to an embodiment of the present disclosure.

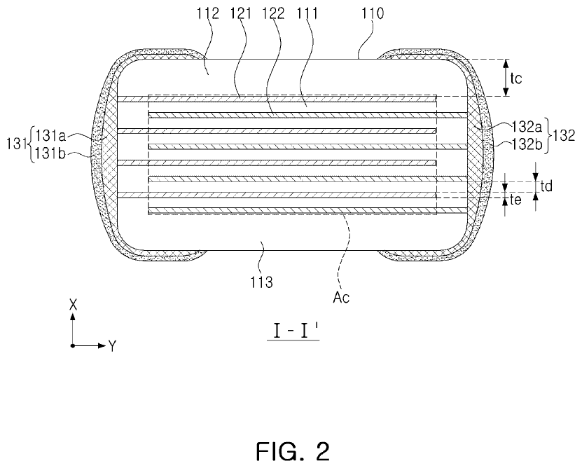

FIG. 2 schematically illustrates a cross-sectional view taken along line I-I′ of FIG. 1.

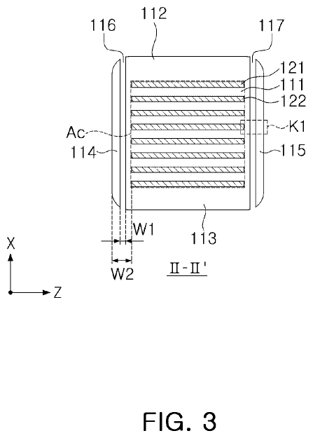

FIG. 3 schematically illustrates a cross-sectional view taken along line II-II′ of FIG. 1.

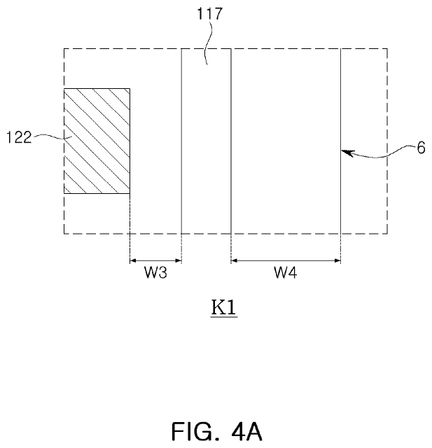

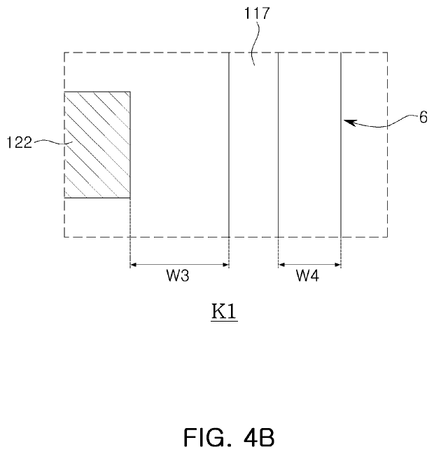

FIGS. 4A and 4B are enlarged views schematically illustrating Region K1 of FIG. 3.

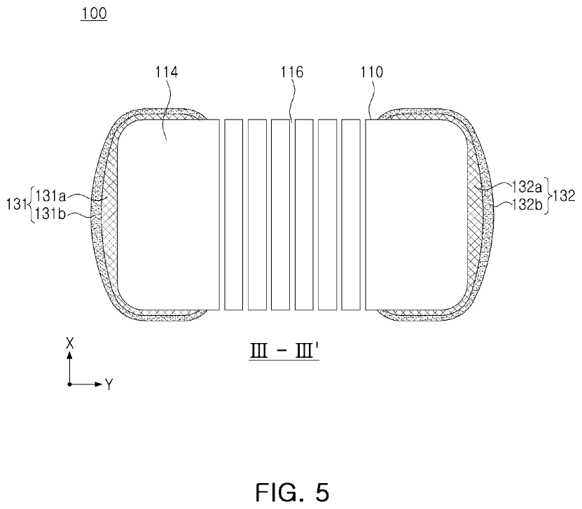

FIG. 5 schematically illustrates a cross-sectional view taken along line III-III′ of FIG. 1.

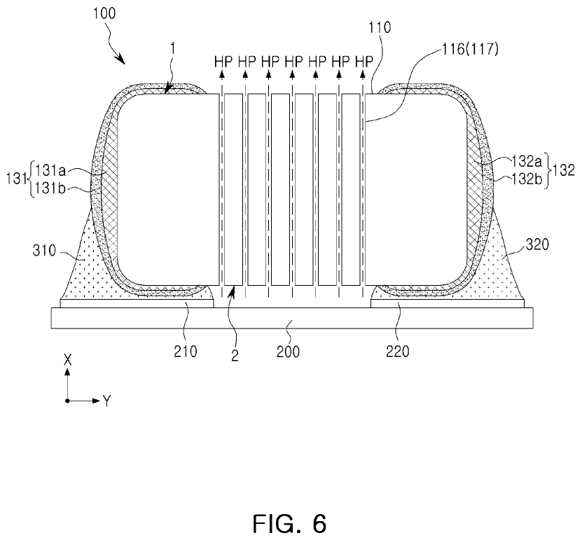

FIG. 6 is a cross-sectional view illustrating a state in which the multilayer electronic component according to an embodiment of the present disclosure is mounted on a printed circuit board.
Hereinafter, a multilayer electronic component 100 according to an embodiment of the present disclosure will be described in detail with reference to FIGS. 1 to 6. In addition, as an example of a multilayer electronic component, a multilayer ceramic capacitor is described, but the present disclosure is not limited thereto and may also be applied to various multilayer electronic components, such as inductors, piezoelectric elements, varistors, or thermistors.

The size of the multilayer electronic component 100 is not particularly limited, but the maximum length of the multilayer electronic component 100 in the second direction may be 0.1 mm to 6.0 mm, the maximum width of the multilayer electronic component 100 in the third direction may be 0.1 mm to 5.0 mm, and the maximum thickness of the multilayer electronic component 100 in the first direction may be 0.05 mm to 3.5 mm.

The multilayer electronic component 100 may include a body 110 and external electrodes 131 and 132.

There is no particular limitation on the specific shape of the body 110, but as illustrated, the body 110 may have a hexahedral shape or a shape similar thereto. Due to shrinkage of ceramic powder particles included in the body 110 during a sintering process or due to the polishing process of the corner portions of the body 110, the body 110 may not have a hexahedral shape with entirely straight lines, but may have a substantially hexahedral shape.

The body 110 may have first and second surfaces 1 and 2 opposing each other in the first direction, third and fourth surfaces 3 and 4 connected to the first and second surfaces 1 and 2 and opposing each other in the second direction, and fifth and sixth surfaces 5 and 6 connected to the first to fourth surfaces 1, 2, 3, and 4 and opposing each other in the third direction.

The body 110 may include a dielectric layer 111 and internal electrodes 121 and 122 disposed alternately with the dielectric layer 111 in the first direction. A plurality of dielectric layers 111 are in a sintered state, such that boundaries between adjacent dielectric layers 111 may be integrated so as to be difficult to identify without using a scanning electron microscope (SEM).

The dielectric layer 111 may include, for example, a perovskite-type compound represented by ABO₃ as a main component. The perovskite-type compound represented by ABO₃ may include, for example, one or more of BaTiO₃, (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1), Ba(Ti_{1-y}Zr_{y})O₃ (0<y<1), CaZrO₃ and (Ca₁₋ₓSrₓ)(Zr_{1-y}Ti_{y})O₃ (0<x≤0.5, 0<y≤0.5).

An average thickness td of the dielectric layer 111 is not particularly limited. The average thickness td of the dielectric layer 111 may be, for example, 0.1 μm to 20 μm, 0.1 μm to 10 μm, 0.1 μm to 5 μm, 0.1 μm to 2 μm, or 0.1 μm to 0.4 μm.

The internal electrodes 121 and 122 may include, for example, a first internal electrode 121 and a second internal electrode 122 that are alternately disposed in the first direction with the dielectric layer 111 interposed therebetween. The first internal electrode 121 and the second internal electrode 122, a pair of electrodes having different polarities, may be disposed opposing each other with the dielectric layer 111 therebetween.

The first internal electrode 121 may be spaced apart from the fourth, fifth and sixth surfaces 4, 5, and 6 and may be connected to the first external electrode 131 on the third surface 3. The second internal electrode 122 may be spaced apart from the third, fifth and sixth surfaces 3, 5, and 6 and may be connected to the second external electrode 132 on the fourth surface 4.

A conductive metal included in the internal electrodes 121 and 122 may be one or more of Ni, Cu, Pd, Ag, Au, Pt, Sn, W, Ti, and alloys thereof, and more preferably, the internal electrodes 121 and 122 may include Ni, but the present disclosure is not limited thereto.

An average thickness te of the internal electrodes 121 and 122 is not particularly limited. The average thicknesses te of the internal electrodes 121 and 122 may be, for example, 0.1 μm to 3.0 μm, 0.1 μm to 1.0 μm, or 0.1 μm to 0.4 μm.

The average thickness td of the dielectric layer 111 and the average thickness te of the internal electrodes 121 and 122 respectively refers to average thicknesses of the dielectric layer 111 and the internal electrodes 121 and 122 in the first direction. The average thickness td of the dielectric layer 111 and the average thickness te of the internal electrodes 121 and 122 may be measured by scanning a cross section of the body 110 in the first and second direction with a scanning electron microscope SEM of 10,000× magnification. More specifically, the average thickness td of the dielectric layer 111 may be measured by calculating the average after measuring the thickness at a plurality of points of one dielectric layer 111, for example, at 5 points equally spaced apart from each other in the second direction, and then taking the average value. In addition, the average thicknesses te of the internal electrodes 121 and 122 may be measured by calculating the average after measuring the thicknesses at a plurality of points of one internal electrode 121 and 122, for example, at 5 points equally spaced apart from each other in the second direction. The 5 points equally spaced apart from each other may be designated in the capacitance formation portion Ac. Meanwhile, when the average value measurements are performed for each of 10 dielectric layers 111 and 10 internal electrodes 121 and 122, and then the average values may be calculated, the average thickness td of the dielectric layer 111 and the average thicknesses te of the internal electrodes 121 and 122 may be further generalized.

The body 110 may include the capacitance formation portion Ac including the dielectric layer 111 and the internal electrodes 121 and 122 to form capacitance, and cover portions 112 and 113 disposed on both surfaces of the capacitance formation portion Ac opposing in the first direction.

An average thicknesses tc of the cover portions 112 and 113 may not be particularly limited. The average thickness tc of the cover portions 112 and 113 may be, for example, 150 μm or less, 100 μm or less, 30 μm or less, or 20 μm or less. The average thicknesses tc of the cover portions 112 and 113 may be, for example, 5 μm or more, 10 μm or more, or 30 μm or more. The average thicknesses tc of the cover portions 112 and 113 may refer to an average thickness of each of the first cover portion 112 and the second cover portion 113.

The average thickness tc of the cover portions 112 and 113 may refer to an average thickness of the cover portions 112 and 113 in the first direction, and may be an average value of thicknesses in the first direction measured at 5 points equally spaced apart from each other in a cross-section of the body 110 in the first and second directions.

The body 110 may include margin portions 114 and 115 disposed on both surfaces of the capacitance formation portion Ac opposing in the third direction and on both surfaces of the cover portions 112 and 113 opposing in the third direction. That is, the internal electrodes 121 and 122 may be spaced apart from the fifth and sixth surfaces 5 and 6 with the margin portions 114 and 115 therebetween.

The margin portions 114 and 115 may include a first margin portion 114 disposed between the internal electrodes 121 and 122 and the fifth surface 5 and a second margin portion 115 disposed between the internal electrodes 121 and 122 and the sixth surface 6. That is, the capacitance formation portion Ac may be disposed between the first margin portion 114 and the second margin portion 115.

The cover portions 112 and 113 and the margin portions 114 and 115 may have a similar configuration to the dielectric layer 111 except for not including internal electrodes 121 and 122. That is, the cover portions 112 and 113 and the margin portions 114 and 115 may refer to a region where the internal electrodes 121 and 122 is not disposed. The cover portions 112 and 113 may configure an external region of the body 110 in the first direction, and the margin portions 114 and 115 may configure an external region of the body 110 in the third direction.

A size of the margin portions 114 and 115 is not particularly limited, but a width of the capacitance formation portion Ac may be greater than a width of the first margin portion 114 and a width of the second margin portion 115. In this case, the width of the capacitance formation portion Ac may refer to a width of the capacitance formation portion Ac in the third direction, and the width of the margin portions 114 and 115 may refer to a width of the margin portions 114 and 115 in the third direction.

An average width of the margin portions 114 and 115 may be, for example, 150 μm or less, 100 μm or less, 20 μm or less, or 15 μm or less. The average width of the margin portions 114 and 115 may be, for example, 5 μm or more, 10 μm or more, or 30 μm or more. In this case, the average width of the margin portions 114 and 115 may refer to an average width of each of the first margin portion 114 and the second margin portion 115.

The average width of the margin portions 114 and 115 may refer to an average width of the margin portions 114 and 115 in the third direction, and may be an average value of the average widths in the third direction measured at 5 points equally spaced apart from each other in a cross-section of the body 110 in the first and third directions.

The external electrodes 131 and 132 may be disposed on the third and fourth surfaces 3 and 4 respectively. The external electrodes 131 and 132 may include the first external electrode 131 disposed on the third surface 3 and extending onto portions of the first, second, fifth and sixth surfaces 1, 2, 5, and 6, and the second external electrode 132 disposed on the fourth surface 4 and extending onto portions of the first, second, fifth and sixth surfaces 1, 2, 5, and 6.

Types or shapes of the external electrodes 131 and 132 may not be particularly limited, and may have a multilayer structure. For example, the external electrodes 131 and 132 may include base electrode layers 131a and 132a in contact with the internal electrodes 121 and 122 and plating layers 131b and 132b disposed on the base electrode layers 131a and 132a.

The base electrode layers 131a and 132a may be sintered electrode layers including metal and glass. The metal included in the base electrode layers 131a and 132a may include, for example, Cu, Ni, Pd, Pt, Au, Ag, Pb, and/or alloys thereof. The glass included in the base electrode layers 131a and 132a may include, for example, one or more oxides of Ba, Ca, Zn, Al, B, and Si.

Meanwhile, the base electrode layers 131a and 132a may be configured by only the sintered electrode layer, but the present disclosure may not be limited thereto, and the base electrode layers 131a and 132a may include, a sintered electrode layer including metal and glass, and a resin electrode layer disposed on the sintered electrode layer and including metal particles and resin.

The metal included in the resin electrode layer may include, for example, Cu, Ni, Pd, Pt, Au, Ag, Pb, Sn and/or alloys thereof. The resin included in the resin electrode layer may include, for example, one or more of epoxy resin, acrylic resin, and ethyl cellulose.

The plating layers 131b and 132b may include, for example, Ni, Sn, Pd and/or alloys thereof, and may be formed of a plurality of layers. The plating layers 131b and 132b may be, for example, Ni plating layer or Sn plating layer, and may also be in the form in which the Ni plating layer and the Sn plating layer are formed sequentially thereon. The plating layers 131b and 132b may include a plurality of Ni plating layers and/or a plurality of Sn plating layers.

Although the drawing describes a structure in which a multilayer electronic component 100 has two external electrodes 131 and 132, it may not be limited thereto, and the number or shape of the external electrodes 131 and 132 may be changed depending on the shape of the internal electrodes 121 and 122 or other purposes.

According to an embodiment of the present disclosure, through-holes 116 and 117 penetrating the first and second surfaces 1 and 2, and having an empty space therein may be disposed in the margin portions 114 and 115. For example, the body 110 may include the through-holes 116 and 117 disposed in a region between the internal electrodes 121 and 122 and the fifth or sixth surface 5 and 6, and the through-holes 116 and 117 may penetrate the first and second surfaces 1 and 2, and may have an empty space therein. The through-holes 116 and 117 may perform a function as heat dissipation portions releasing heat generated in the capacitance formation portion Ac.

The through-holes 116 and 117 may include a first through-hole 116 disposed between the internal electrodes 121 and 122 and the fifth surface 5 and a second through-hole 117 disposed between the internal electrodes 121 and 122 and the sixth surface 6. The through-holes 116 and 117 may include, for example, the first through-hole 116 disposed in the first margin portion 114 and the second through-hole 117 disposed in the second margin portion 115. The through-holes 116 and 117 may include, for example, the first through-hole 116 disposed in the region between the internal electrodes 121 and 122 and the fifth surface 5, and the second through-hole 117 disposed in the region between the internal electrodes 121 and 122 and the sixth surface 6.

Referring to FIG. 6, the multilayer electronic component 100 may be mounted on a printed circuit board 200. The external electrodes 131 and 132 of the multilayer electronic component 100 may be connected to pads 210 and 220 disposed on a surface of the printed circuit board 200 through solders 310 and 320. Meanwhile, when current flows through internal conductors of the printed circuit board 200, heat may be generated in the printed circuit board 200. Accordingly, a temperature difference may generate between the air on an upper portion of the multilayer electronic component 100 and the air on a lower portion of the multilayer electronic component 100. The air on the upper portion of the multilayer electronic component 100 may have a higher temperature than the air on the lower portion, and a convection phenomenon may occur due to the temperature difference. In this case, the through-holes 116 and 117 may form a heat dissipation path (HP), and heat generated inside the multilayer electronic component 100 may be effectively released through the convection phenomenon. To induce the convection phenomenon, the through-holes 116 and 117 may have an empty space extending in the first direction to allow airflow. In some embodiments, the empty space of the through-holes 116 and 117 is configured to be filled with a heat transfer medium, for example, but not limited to, aluminum nitride, boron nitride, etc. Additionally, the first or second surfaces 1 or 2 may be a mounting surface of a multilayer electronic component 100.

The number of through-holes 116 and 117 is not particularly limited, but in order to effectively release the heat generated inside the multilayer electronic component 100, a plurality of the first through-hole 116 and the second through-hole 117 may be respectively disposed. A plurality of first through-hole 116 may be disposed to be spaced apart from each other in the second direction, and a plurality of second through-hole 117 may be disposed to be spaced apart from each other in the second direction.

For example, the number of first and second through-holes 116 and 117 may be 2 or more, 5 or more, 10 or more, 50 or more, or 100 or more, respectively. The maximum limit of the number of the first and second through-holes 116 and 117 is not particularly limited and may be appropriately selected in consideration of a length of the body 110 in the second direction and a width of the first and second through-holes 116 and 117.

It is sufficient that the through-holes 116 and 117 may be disposed in a region between the internal electrodes 121 and 122 and the fifth or sixth surfaces 5 or 6, and specific positions of the through-holes 116 and 117 are not limited. However, when the through-holes 116 and 117 penetrate a portion of the capacitance formation portion Ac, external moisture may easily penetrate into the inside of the capacitance formation portion Ac through the through-holes 116 and 117, and as a result, there is a concern that the moisture resistance reliability of the multilayer electronic component 100 may be reduced. Accordingly, it may be desirable for the through-holes 116 and 117 to be spaced apart from the capacitance formation portion Ac.

Sizes or shapes of the through-holes 116 and 117 are not particularly limited. The through-holes 116 and 117 may have a columnar shape. The columnar shape may refer to a long rod-like shape having an aspect ratio greater than 1 or bar-like shape, such as a circular columnar shape or a polygonal columnar shape. The through-holes 116 and 117 may have, for example, a columnar shape having a constant width.

In one embodiment, when a width of the through-holes 116 and 117 is W1 and a width of the margin portions 114 and 115 is W2, 0.2 ≤W1/W2≤0.4 may be satisfied. When W1/W2 is less than 0.2, the heat dissipation effect of the present disclosure may not be sufficient, and when W1/W2 is more than 0.4, there is a concern that a path for external moisture to penetrate may be excessively provided. The W1 may refer to a width of the through-holes 116 and 117 in the third direction, and the W2 may refer to, for example, a width of the margin portions 114 and 115 in the third direction.

Meanwhile, heat generated inside the multilayer electronic component 100 may be mainly generated in the capacitance formation portion Ac. Accordingly, the closer the through-holes 116 and 117 is to the capacitance formation portion Ac, the more effectively the heat generated inside the multilayer electronic component 100 may be released. However, the closer the through-holes 116 and 117 is to the capacitance formation portion Ac, the more easily external moisture may penetrate into the inside of the capacitance formation portion Ac through the through-holes 116 and 117. Accordingly, a position of the through-holes 116 and 117 may vary depending on preferred characteristics or types of the multilayer electronic component 100.

Referring to FIGS. 3 and 4A, in an embodiment, a distance W3 between the through-holes 116 and 117 and the internal electrodes 121 and 122 in a third direction may be smaller than a distance W4 between the through-holes 116 and 117 and a surface closer to the through-holes 116 and 117 among the fifth and sixth surfaces 5 and 6 in the third direction. W4 may refer to, for example, a distance between the first through-hole 116 and the fifth surface 5 in the third direction or a distance between the second through-hole 117 and the sixth surface 6 in the third direction. When W3<W4 is satisfied, the through-holes 116 and 117 may effectively release heat generated in the capacitance formation portion Ac. For example, in the case of the multilayer electronic component 100 mounted on electrical components and subjected to high voltage, internal heat generation may be particularly greater, therefore, the through-holes 116 and 117 may be disposed to satisfy W3<W4.

Referring to FIGS. 3 and 4B, in an embodiment, W4<W3 may be satisfied. In this case, the through-holes 116 and 117 are sufficiently spaced apart from the capacitance formation portion Ac, so that a phenomenon of external moisture penetrating into the inside of the capacitance formation portion Ac may be suppressed. For example, in case of a small-sized multilayer electronic component 100 used for IT purposes, it may be more vulnerable to external moisture penetration, therefore, through-holes 116 and 117 may be disposed to satisfy W4<W3.

However, the present disclosure is not limited thereto, and the multilayer electronic component 100 mounted on the electrical components and subjected to high voltage may also satisfy W4<W3, and the small-sized multilayer electronic component 100 used for IT purposes may also satisfy W3<W4.

The W1, W2, W3 and W4 may be measured, for example, from images taken by using a scanning electron microscope (SEM) of a region of the margin portions 114 and 115 after exposing cross-sections of the multilayer electronic component 100 in the first and third direction passing through a center portion of the through-holes 116 and 117.

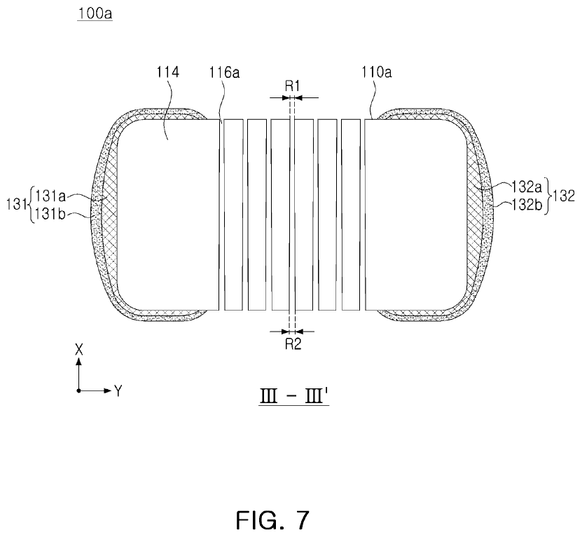

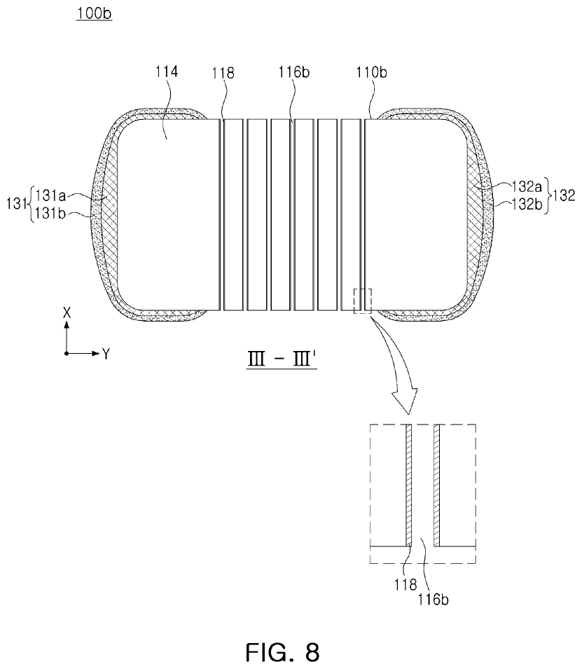

FIG. 7 is a cross-sectional view schematically illustrating a multilayer electronic component 100a according to another embodiment of the present disclosure, and is a drawing corresponding to FIG. 5. FIG. 8 is a cross-sectional view schematically illustrating a multilayer electronic component 100b according to another embodiment of the present disclosure, and is a drawing corresponding to FIG. 5.

Hereinafter, a multilayer electronic components 100a and 100b according to another embodiment of the present disclosure will be described with reference to FIGS. 7 and 8. For configurations identical/similar to those of the multilayer electronic components 100 described in FIGS. 1 to 6, identical/similar reference symbols will be used, and duplicate descriptions will be omitted.

Referring to FIG. 7, the body 110a of the multilayer electronic component 100a may include a through-hole 116a disposed in the margin portion 114. Meanwhile, when a width of the through-hole 116a measured from the first surface 1 is R1 and a width of the through-hole 116a measured from the second surface 2 is R2, R2 may be greater than R1. For example, the width of the through-hole 116a may gradually decrease from the second surface 2 toward the first surface 1. For example, the through-hole 116a may have a reverse taper shape in which the width increases from the upper surface to the lower surface of the body 110a. The term “gradually” means a width or the like changes “continuously”, “step by step”, or a combination of them.

When the second surface 2 is a mounting surface, a convection phenomenon may be generated inside the through-hole 116a in the direction from the second surface 2 toward the first surface 1. In this case, when R1 becomes narrower than R2, velocity of fluid inside the through-hole 116a may increase as it is closer in the first surface 1, thereby enhancing heat generated inside the multilayer electronic component 100a to be released more effectively.

Referring to FIG. 8, the body 110b of the multilayer electronic component 100b may include a through-hole 116b disposed in the margin portion 114. A coating layer 118 including an organic compound may be disposed on a side wall of the through-hole 116b.

The through-hole 116b may perform a function of releasing heat generated inside the multilayer electronic component 100b, but the through-hole 116b may be a portion vulnerable to external moisture penetration. As the coating layer 118 may be disposed on the side wall of the through-hole 116b, external moisture may prevent from penetrating into the inside of the body 110b.

An organic compound included in the coating layer 118 may include, for example, an organosilicon compound. The organosilicon compound may include, for example, a repeating unit derived from an alkoxy silane represented by the following Chemical Expression 1. The repeating unit derived from an alkoxy silane may refer to a repeating unit having a structure obtained by a hydrolysis reaction and a dehydration condensation reaction of an alkoxy silane.

### [Chemical Expression 1]

R—Si(OR′)3 (where R is an alkyl group of C1 to C20 and R′ is an alkyl group of C1 to C6)

Meanwhile, FIG. 8 illustrates a structure in which a coating layer 118 is disposed only on the side wall of the through-hole 116b, but the present disclosure is not limited thereto. For example, the coating layer 118 may be disposed to cover at least a portion of the external surface of the body 110b, and may be disposed to cover at least a portion of the external surface of the external electrodes 131 and 132.

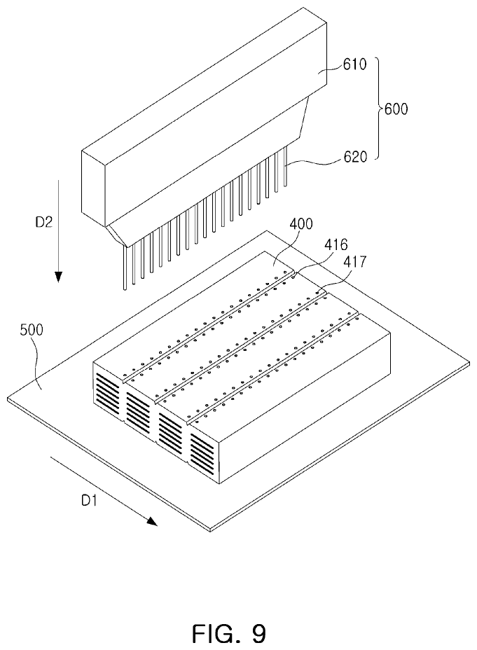

FIG. 9 is a perspective view schematically illustrating a method for manufacturing a multilayer electronic component according to one embodiment of the present disclosure. Hereinafter, an example of a method for forming the multilayer electronic component 100 will be described with reference to FIG. 9. However, the manufacturing method of the multilayer electronic component 100 is not limited thereto.

First of all, ceramic powder for forming a dielectric layer 111 are prepared. The ceramic powder may include, for example, one or more of BaTiO₃, (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1), Ba(Ti_{1-y}Zr_{y})O₃ (0<y<1), CaZrO₃, and (Ca₁₋ₓSrₓ)(Zr_{1-y}Ti_{y})O₃ (0<x≤0.5, 0<y≤0.5). BaTiO₃ powder may be synthesized, for example, by reacting a titanium raw material such as titanium dioxide with a barium raw material such as barium carbonate. A synthesizing method of the ceramic powder may include methods, for example, a solid phase method, a sol-gel method, a hydrothermal synthesis method, or the like, but the present disclosure may not be limited thereto. Next, the prepared ceramic powder are dried and ground, and then an organic solvent such as ethanol, and a binder such as polyvinyl butyral, or the like are mixed to prepare a ceramic slurry, and then the ceramic slurry is applied and dried on a carrier film to prepare a ceramic green sheet.

Next, conductive paste for an internal electrode containing metal powder, binder, organic solvent, or the like is printed onto the ceramic green sheet with a predetermined thickness using a screen printing method or a gravure printing method, thereby forming an internal electrode pattern.

Thereafter, the ceramic green sheet having the internal electrode pattern printed thereon is peeled off from the carrier film, and then the ceramic green sheet having the internal electrode pattern printed in a predetermined amount of layers are multilayered and pressed to form ceramic multilayer 400. On the upper and lower portions of the ceramic multilayer, a ceramic green sheet forming a cover portion without an internal electrode pattern, may be multilayered in a predetermined amount of layers to form the cover portion after sintering.

The ceramic laminate 400 may be fixed on a vacuum stage 500, and the vacuum stage 500 may move in a horizontal direction D1. A punching jig 600 may be disposed on an upper portion of the ceramic laminate 400. The punching jig 600 may include a holder 610 and a plurality of punching pins 620 coupled to the holder 610. The punching jig 600 may move in the vertical direction D2 to form through-holes 416 and 417 in the ceramic multilayer 400.

Thereafter, the ceramic multilayer 400 may be cut along a plurality of preset first and second cutting lines to have a predetermined chip size. The first and second cutting lines are perpendicular to each other, and one of the first and second cutting lines may be disposed between a first through-hole 416 and a second through-hole 417. Next, the cut chip may be sintered to form the body 110. The sintering may be performed, for example, in an atmosphere of 1.0% H₂/99.0% N₂˜3.5% H₂/96.5% N₂ (H₂O/H₂/N₂), at a temperature of 1000° C. or higher and 1400° C. or lower for 1 to 3 hours.

Next, the external electrodes 131 and 132 may be formed. For example, when the base electrode layers 131a and 132a include a sintered electrode layer, the ceramic body 110 may be dipped in the external electrode conductive paste including metal powder, glass frit, binder, and an organic solvent, and then the external electrode conductive paste may be sintered at a temperature of 500° C. to 900° C. to form a sintered electrode layer.

For example, when the base electrode layers 131a and 132a include a resin electrode layer, the body may be dipped in a conductive resin composition including metal powder, resin, binder, and organic solvent, followed by curing heat treatment at a temperature of 250° C. to 550° C. to form the resin electrode layer.

In addition, an electrolytic plating method and/or an electroless plating method may be additionally performed to form plating layers 131b and 132b on the base electrode layers 131a and 132a.

The multilayer electronic component 100a may be manufactured, for example, by changing a shape of the punching pin 620 to a conical shape.

The multilayer electronic component 100b may be manufactured, for example, by immersing the body 110b formed with the plating layers 131b and 132b in an organic coating liquid and then drying it to form a coating layer 118. The organic coating liquid may include an alkoxy silane represented by R—Si(OR′)₃ (where R is an alkyl group having C1 to C20 and R′ is an alkyl group having C1 to C6) and a solvent such as alcohol. The drying temperature is not particularly limited, but may be, for example, 100° C. to 200° C.

The present disclosure is not limited to the above-described embodiments and the accompanying drawings but is defined by the appended claims. Therefore, those of ordinary skill in the art may make various replacements, modifications, or changes without departing from the scope of the present disclosure defined by the appended

claims, and these replacements, modifications, or changes should be construed as being included in the scope of the present disclosure.

In addition, the expression ‘an example embodiment’ does not mean the same embodiment, and is provided to emphasize and explain different unique characteristics. However, the embodiments presented above do not preclude being implemented in combination with the features of another embodiment. For example, although items described in a specific embodiment are not described in another embodiment, the items may be understood as a description related to another embodiment unless a description opposite or contradictory to the items is in another embodiment.

In the present disclosure, the term “connected” includes not only direct connection but also indirect connection through an adhesive layer or the like. Additionally, the term electrically connected includes both physically connected and not physically connected. In addition, the terms “first,” “second,” and the like may be used to distinguish one element from another, and may not limit a sequence and/or an importance, or others, in relation to the elements. In some cases, a first element may be referred to as a second element, and similarly, a second element may be referred to as a first element without departing from the scope of right of the example embodiments.

While the embodiments have been illustrated and described above, it will be configured as apparent to those skilled in the art that modifications and variations could be made without departing from the scope of the present disclosure as defined by the appended claims.

1. A multilayer electronic component comprising:
a body including a dielectric layer and internal electrodes alternately disposed within the dielectric layer in a first direction, the body having a first surface and a second surface opposing each other in the first direction, a third surface and a fourth surface connected to the first surface and the second surface, respectively, and opposing each other in a second direction, and a fifth surface and a sixth surface connected to the first surface, the second surface, the third surface, and the fourth surfaces and opposing each other in a third direction; and
external electrodes disposed on the third surface and the fourth surface, respectively,
wherein at least one of the internal electrodes is spaced apart from the fifth surface and the sixth surface with a margin portion therebetween, and
wherein a through-hole is disposed in the margin portion, the through-hole penetrating the first surface and the second surface and having an empty space therein.

2. The multilayer electronic component of claim 1, wherein the through-hole includes a first through-hole disposed between the internal electrodes and the fifth surface and a second through-hole disposed between the internal electrodes and the sixth surface.

3. The multilayer electronic component of claim 2, wherein the first through-hole comprises a plurality of first through-holes and the second through-hole includes a plurality of second through-holes.

4. The multilayer electronic component of claim 3, wherein the plurality of first through-holes are spaced apart from each other in the second direction, and
wherein the plurality of second through-holes are spaced apart from each other in the second direction.

5. The multilayer electronic component of claim 1, wherein W1 and W2 satisfy 0.2≤W1/W2≤0.4, and
wherein a width of the through-hole is W1 and a width of the margin portion is W2.

6. The multilayer electronic component of claim 1, wherein W3 and W4 satisfy W3<W4, and
wherein a distance between the through-hole and the internal electrode in the third direction is W3, and a distance between the through-hole and a surface closer to the through-hole among the fifth surface and the sixth surface in the third direction is W4.

7. The multilayer electronic component of claim 1, wherein W3 and W4 satisfy W4<W3, and
wherein a distance between the through-hole and the internal electrodes in the third direction is W3, and a distance between the through-hole and a surface closer to the through-hole among the fifth surface and the sixth surface in the third direction is W4.

8. The multilayer electronic component of claim 1, wherein the margin portion includes a first margin portion disposed between the internal electrodes and the fifth surface and a second margin portion disposed between the internal electrode and the sixth surface,
wherein the body includes a capacitance formation portion disposed between the first margin portion and the second margin portion, and including the dielectric layer and the internal electrodes, and
wherein the through-hole is spaced apart from the capacitance formation portion.

9. The multilayer electronic component of claim 1, wherein the margin portion includes a first margin portion disposed between the internal electrodes and the fifth surface and a second margin portion disposed between the internal electrode and the sixth surface,
wherein the body includes a capacitance formation portion disposed between the first margin portion and the second margin portion, and including the dielectric layer and the internal electrodes,
wherein a width of the capacitance formation portion is greater than a width of the first margin portion and a width of the second margin portion.

10. The multilayer electronic component of claim 1, wherein the through-hole has a columnar shape.

11. The multilayer electronic component of claim 1, wherein R2 is greater than the R1, and
wherein a width of the through-hole measured on the first surface is R1 and a width of the through-hole measured on the second surface is R2.

12. The multilayer electronic component of claim 1, wherein a width of the through-hole gradually decreases from the second surface toward the first surface.

13. The multilayer electronic component of claim 1, wherein a coating layer including an organic compound is disposed on a sidewall of the through-hole.

14. The multilayer electronic component of claim 1, wherein the empty space is configured to allow airflow and thereby induce the convection phenomenon.

15. The multilayer electronic component of claim 1, wherein the empty space is configured to be filled with a heat transfer medium other than air.
